(19) United States
(12) Patent Application Publication
(10) Pub. No.: US 2025/0170814 A1
(43) Pub. Date: May 29, 2025

(54) METHOD FOR CONNECTING SHEET METAL PARTS TO FORM LAMINATION STACKS, AND DEVICE FOR CARRYING OUT THE METHOD

(71) Applicant: voestalpine Automotive Components Dettingen GmbH & Co. KG, Dettingen an der Erms (DE)

(72) Inventor: Heinrich Bursy, Erkenbrechtsweiler (DE)

(21) Appl. No.: 18/843,777

(22) PCT Filed: Mar. 3, 2023
(86) PCT No.: PCT/EP2023/055502

§ 371 Date: Sep. 4, 2024

(30) Foreign Application Priority Data
Mar. 4, 2022 (EP) 22160359.0

(51) Int. Cl. B32B 37/12; B32B 7/12; B32B 15/01

(52) U.S. Cl. CPC B32B 37/1207; B32B 7/12; B32B 15/011; B32B 2037/1215; B32B 2307/718; B32B 2307/7376

(57) ABSTRACT

A method for connecting sheet metal parts to form lamination stacks and a device for carrying out the method are disclosed. Improved reproducibility of the method and improved reliability of the device can be achieved if the adhesive coating of the dividing element consists of a UV-cross-linked acrylic-based hot-melt pressure-sensitive adhesive (HMPSA).

### TECHNICAL FIELD

The invention relates to a method for connecting sheet metal parts to form lamination stacks and a device for carrying out the method.

### PRIOR ART

In order to make it easier to divide stacked sheet metal parts into lamination stacks, it is known, to provide dividing elements between two respective sheet metal parts. These dividing elements have a flat support with an adhesive coating on one side and a nonstick coating on the other side. Because of a thermal activation of the hot-melt adhesive varnish layer in the stacked sheet metal parts, significant thermal and mechanical loads on the dividing element are produced, which can lead to a squeezing-out of this adhesive varnish or portions thereof and even to a failure of its dividing function. This not only reduces the reproducibility of the method, but can also lead to unwanted adhesions to the device, which impairs its function.

### SUMMARY OF THE INVENTION

The object of the invention, therefore, is to improve the reproducibility of a method for producing lamination stacks of the type mentioned at the beginning.

Because the adhesive coating consists of a UV-cross-linked acrylic-based hot-melt pressure-sensitive adhesive (HMPSA), it is possible to ensure that the function of the dividing element in the stack is preserved in spite of a comparatively high surface pressure and a comparatively high temperature. Specifically, thanks to the use of the UV-cross-linked hot-melt pressure-sensitive adhesive, it is not necessary to fear that the adhesive of the dividing element will be squeezed out—which can reliably ensure the required quality in the lamination stacks produced.

The danger of the adhesive coating on the support being squeezed out can be reduced further if it has a weight per unit area in the range from 9 to 13 g/m². This weight per unit area can nevertheless provide a sufficient adhesive action on the sheet metal part or lamination stack. Preferably, this adhesive coating has a weight per unit area of 11 g/m².

The foregoing can be further improved if the adhesive coating on the support has a layer thickness in the range from 10 to 17 μm. Preferably, the adhesive coating on the support has a layer thickness in the range from 13 to 16 μm.

The mechanical stability of the dividing element in the method can be further improved if the support is composed of a woven, a nonwoven, or a film. Preferably, the support is composed of a polyester film (PET film).

If the support has a support thickness in the range from 40 to 60 μm, then this can already provide a sufficient mechanical stability. Preferably, the film support has a support thickness of 50 μm.

The dividing of the sheet metal parts into lamination stacks in the method can be made even easier if the dividing element has a nonstick coating on the flat side of the support opposite from the flat side of the support with the adhesive coating.

Preferably, this nonstick coating is silicone-based in order to enable a residue-free removal from the respective sheet metal part or lamination stack.

For example, the nonstick coating can be a cross-linked, more particularly solvent-free, silicone coating. For example, the silicone coating can be thermally cross-linked.

A layer thickness of the nonstick coating in the range from 1.0 to 3.5 μm, more particularly from 2.0 to 3.0 μm, can be enough to achieve a sufficient anti-adhesive property.

Another stated object of the invention is to improve the reliability of a device for carrying out the method according to the invention.

Because the adhesive coating consists of a UV-cross-linked acrylic-based hot-melt pressure-sensitive adhesive (HMPSA), it is possible to reduce or entirely avoid the danger of the stacking unit of the device becoming stuck because of the adhesive of the dividing element being squeezed out. It is thus possible to further increase the reliability of the device.

Another stated object of the invention is to ensure that a facilitated dividing of lamination stacks is preserved even when a dividing element is exposed to high surface pressures and temperatures.

This dividing can happen more reliably if a dividing element is used that has a flat support with an adhesive coating consisting of a UV-cross-linked acrylic-based hot-melt pressure-sensitive adhesive on one flat side of the support and the dividing element is stacked together with sheet metal parts and these sheet metal parts are connected to one another through integral joining to form lamination stacks-specifically in spite of comparatively high thermal and physical loads on the dividing element.

This can be further improved if the adhesive coating on the support has a weight per unit area in the range from 9 to 13 g/m², more particularly 11 g/m². Alternatively or additionally, the adhesive coating can have a layer thickness in the range from 10 to 17 μm, more particularly 13 to 16 μm.

In this use, the mechanical and/or thermal stability of the dividing element can also be further increased if the support is composed of a woven, a nonwoven, or a film, in particular a polyester film.

If the support in this use has a support thickness in the range from 40 to 60 μm, more particularly 50 μ, then this also makes the dividing element more user-friendly.

This is even more the case if the dividing element has a nonstick coating, more particularly a silicone-based nonstick coating, on the flat side of the support opposite from the flat side of the support with the adhesive coating.

For example, a cross-linked, more particularly solvent-free, silicone coating is used as the nonstick coating. For example, the silicone coating can be thermally cross-linked.

A layer thickness of the nonstick coating in the range from 1.0 to 3.5 μm, more particularly from 2.0 to 3.0 μm, can be enough to achieve a sufficient anti-adhesive property.

Outstanding results can be achieved if the lamination stack has a dividing element at one or both of its ends.

This dividing element can also form an electrical insulation layer.

### BRIEF DESCRIPTION OF THE DRAWINGS

By way of example, the subject of the invention is depicted in greater detail in the drawings. In the drawings:

FIG. 1 shows a partially cutaway side view of a device for carrying out a method for connecting sheet metal parts to form lamination stacks and

FIG. 2 shows a cross-sectional view through a dividing element for the subject of the invention.

### DETAILED DESCRIPTION OF THE INVENTION

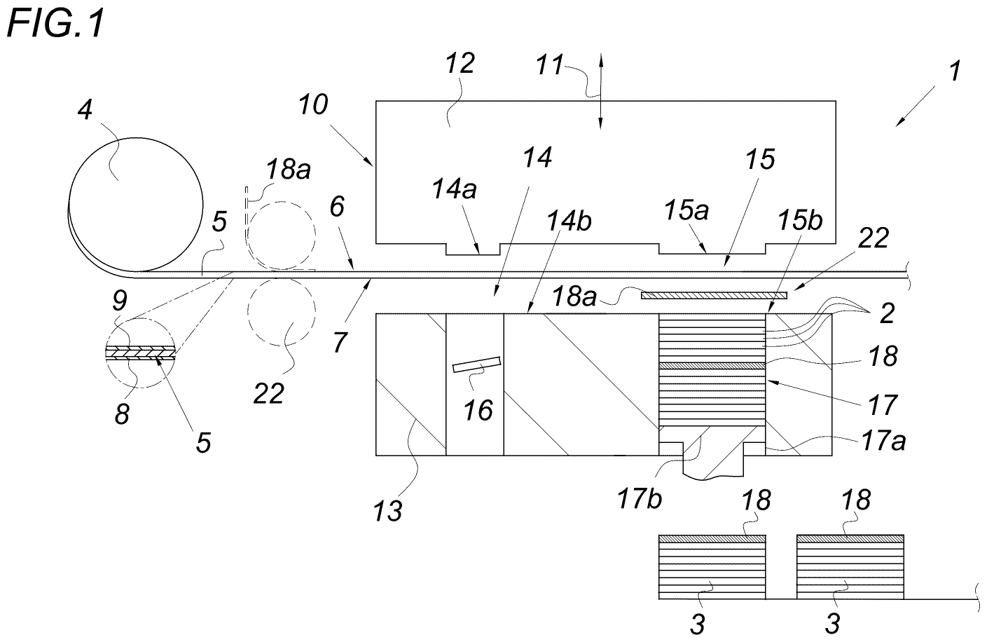

FIG. 1 schematically depicts an embodiment of a device 1 for carrying out the method according to the invention. This device 1 is used to bundle separate sheet metal parts 2 to form lamination stacks 3. For this purpose, an electrical strip 5 is unwound from a coil 4, which strip is entirely covered on one of its flat sides 6 or 7 or—as shown in FIG. 1—on both of its flat sides 6, 7 with a thermally activatable and thus curable hot-melt adhesive varnish layer 8, 9.

It should be noted in general that such a thermally activatable or heat-hardened hot-melt adhesive varnish layer 8, 9 or hot-melt adhesive layer is also known by the term “backlack”. For example, the hot-melt adhesive varnish can be based on an epoxy resin. Preferably, the hot-melt adhesive varnish is a bisphenol-based epoxy resin system with a hardener, for example a dicyandiamide-based hardener. More particularly, the above-mentioned hot-melt adhesive varnish can be a bisphenol-A epichlorohydrin resin system with dicyanamide as the hardener. This two-stage hardening epoxy resin system is in the B-state on the electrical strip 5. Consequently, the partially cross-linked hot-melt adhesive varnish is still reactive. When heat is supplied, the hot-melt adhesive varnish in the B-state reacts further and can thus be transformed into the fully cross-linked C-state-which is also referred to as baking. Typically, this partially cross-linked hot-melt adhesive varnish layer 8, 9 has a thickness of a few micrometers.

A plurality of sheet metal parts 2 are stamped out or separated from the backlack-coated electrical strip 5 with the aid of a stamping tool 10, according to FIG. 1 with the aid of a progressive stamping tool or progressive bonding tool. Such a stamping-out can—it should be generally noted—be a cutting out, cutting off, detaching, trimming, breaking up by means of pressing out, etc. A pressing-out of sheet metal parts 2 is also conceivable.

As can also be inferred from FIG. 1, the stamping tool 10 carries out a cutting in a plurality of strokes 11 in which its upper tool 12 cooperates with its lower tool 13. For this purpose, the stamping tool 10 has a plurality of stamping stages 14, 15.

With a punch 14a of the preparatory stamping stage 14 on the upper tool 11, the electrical strip 5 is prepared to be stamped out, after which a second punch 15a of the second and also last stamping stage 15 on the upper tool 11, sheet metal parts 2 are stamped out and thus separated from the electrical strip 5. For this purpose, the punches 14a, 15a cooperate with the respective dies 14b, 15b of the stamping stages 14, 15 on the lower tool 13. A progressive cutting of this kind can be recognized in FIG. 1 among other things by the fact that in the preparatory stamping, a part 16 is separated from the electrical strip 5 in order to prepare the electrical strip 5 for the stamping-out of the sheet metal part 2.

The sheet metal parts 2 that are stamped out with the aid of the stamping stage 15 are pushed by the pressure of the upper tool 11 or punch 15a into a stacking unit 17 and stacked there. For this purpose, the stacking unit 17 has a shaft 17a and a counter support 17b in the lower tool 13. This counter support 17b in the lower tool 13 brakes the sheet metal parts 2, as a result of which these sheet metal parts 2, under pressure of the upper tool 11 and with the aid of the adhesive layer 8, 9 that is present between the sheet metal parts 2, undergo a physical and/or chemical bonding and are thus joined-specifically through thermal activation of the hot-melt adhesive layers 8, 9 between the sheet metal parts 2. The stacking unit 17 is actively heated for this purpose. Aside from this, the lamination stacks 3 can undergo additional hardening steps, not shown, in order to further harden the integral bond between the sheet metal parts 2. In addition, there is the possibility of rotating the stacking unit 17 in order, for example, to form segmented lamination stacks 3 out of layers with a plurality of sheet metal parts 2 that are positioned next to one another and stacked on top of one another—which is likewise not shown.

In order to be able to divide the lamination stacks 3 exiting the stacking unit 17 from one another more easily, at least one dividing element 18 is stacked together with the sheet metal parts 2. For this purpose, the dividing element 18 is embodied to reduce the adhesion to the adhesive layer 8, 9 of at least one sheet metal part 2 adjacent thereto. This achieves a reduced adhesive strength between the sheet metal parts 2 of adjacent lamination stacks 3, which makes it easier to divide the connected sheet metal parts 2 into lamination stacks 3 when they exit the stacking unit 17—as can be seen in FIG. 1.

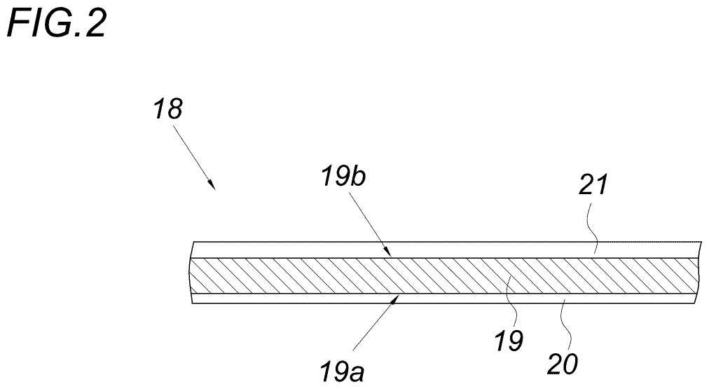

The dividing element 18 shown in an enlarged depiction in FIG. 2 has a flat support 19 or a flat substrate. An adhesive coating 20 is provided directly on the support 19, namely on a first flat side 19a of its two flat sides 19a, 19b.

According to the invention, the adhesive coating 20 consists of a UV-cross-linked (UV-C) acrylic-based hot-melt pressure-sensitive adhesive (HMPSA). It is thus possible to withstand the comparatively high pressures and temperatures during the baking and joining of the sheet metal parts 2 to form lamination stacks 3 in the stacking unit 17. There is thus no need to fear that the adhesive 3 of the adhesive coating 20 will be squeezed out, which keeps both the inner wall of the stacking unit 17 and the lamination stacks 3 exiting this stacking unit 17 free of contamination. The method according to the invention for connecting sheet metal parts 2 to form lamination stacks 3 can therefore achieve the required dimensional accuracy of the lamination stacks 3 in a particularly reproducible way. In addition, there is no fear of the reliability of the device being impaired by accumulations of adhesive in the stacking unit 17.

A dividing element 18 that excels more particularly for this purpose is one that has a support 19 in the form of a polyester film with a support thickness of 49.5 μm (i.e. rounded to 50 μm) in order to withstand high temperatures and pressures in the stacking unit 17.

In the exemplary embodiment, the adhesive coating 20 has a weight per unit area of 11g/m² and a first layer thickness of 14.6 μm—and therefore can provide a sufficient adhesion to a lamination stack 3. It is therefore possible to avoid an inadvertent detachment of the dividing element 18 in the method, which can further increase the reproducibility.

The dividing element 18 reduces the adhesion to an adjacent sheet metal part 2 of another lamination stack 3 in that a silicone-based nonstick coating 21 is provided on the flat side of the support 19b opposite from the flat side of the support 19a with the adhesive coating 20. In the exemplary embodiment, this nonstick coating is a thermally cross-linked silicone coating, which has preferably been applied onto the flat side of the support 19b in a solvent-free way. For this purpose, the silicone coating has a second layer thickness in the range from 2.4 to 2.9 μm.

As a result, the dividing element 18 remains stuck to a lamination stack 3 whereas the dividing element 18 can be more easily divided from the other lamination stack 3, which makes it easier to divide the stacked sheet metal parts 2 into lamination stacks 3.

As is also clear in FIG. 1, the device 1 also has a unit 22 that is used to provide the dividing element 18 between two sheet metal parts 2. To accomplish this, the unit 22 supplies the dividing element 18 in the form of a strip or sheet 18a to the second stamping stage 15 below the electrical strip 5. The second stamping stage 15 stamps the sheet metal part 2 out together with the dividing element 18—and thus also brings it into a form that corresponds to the die 15.2. The dividing element 18 can also be stacked together with the sheet metal parts 2. Depending on the requirements, the strip or sheet is supplied to the stamping stage 15 in order to thus provide a dividing element 18 to the stacking unit 17.

It is also conceivable, however, for the dividing element 18 to be placed onto the electrical strip before the stamping tool 10 or progressive stamping tool, which is shown with dashed lines in FIG. 1.

It should be noted in general that the German expression “insbesondere” can be translated as “more particularly” in English. A feature that is preceded by “more particularly” is to be considered an optional feature, which can be omitted and does not thereby constitute a limitation, for example, of the claims. The same is true for the German expression “vorzugsweise”, which is translated as “preferably” in English.

1. A method for connecting sheet metal parts to form lamination stacks comprising:
detaching sheet metal parts, from an electrical strip, which has a thermally activatable hot-melt adhesive varnish layer on at least one flat side,
stacking the detached sheet metal parts and using thermal activation of the hot-melt adhesive varnish layer to integrally join the detached sheet metal parts to one another to form a plurality of lamination stacks,
wherein when the detached sheet metal parts are stacked, at least one dividing element is added to the plurality of lamination stacks between two of the detached sheet metal parts in order to make it easier to divide the stacked sheet metal parts from one another to form the plurality of lamination stacks, wherein the at least one dividing element has a flat support and an adhesive coating on a first flat side of the flat support and the adhesive coating consists of a UV-cross-linked acrylic-based hot-melt pressure-sensitive adhesive.

2. The method according to claim 1, wherein the adhesive coating on the flat support has a weight per unit area in the a range from 9 to 13 g/m² and/or a layer thickness in the a range from 10 to 17 μm.

3. The method according to one claim 1, wherein the flat support is composed of a material selected from the group consisting of a woven, a nonwoven, a film, and a polyester film.

4. The method according to claim 1, wherein the flat support has a support thickness in the a range from 40 to 60 μm.

5. The method according to claim 1, wherein the at least one dividing element has a nonstick coating on the a second flat side of the flat support opposite from the first flat side of the flat support with the adhesive coating.

6. The method according to claim 5, wherein the nonstick coating is a cross-linked, silicone coating and/or has a layer thickness in the range from 1.0 to 3.5 μm.

7. A device for carrying out the method according to claim 1, comprising:
a stamping tool, which has a stamping stage with a punch for detaching the sheet metal parts from the electrical strip that is coated with the thermally activatable hot-melt adhesive varnish layer on at least one of its flat sides;
a stacking unit for stacking the detached sheet metal parts to form the plurality of lamination stacks; and
a unit that places the at least one dividing element on the electrical strip and/or between two of the detached sheet metal parts in order to thus make it easier to divide the stacked sheet metal parts into the plurality of lamination stacks, wherein the flat support (19) with an of the at least one dividing element has the adhesive coating the first flat sides, and the adhesive coating consists of a UV-cross-linked acrylic-based hot-melt pressure-sensitive adhesive.

8. A method of using a dividing element to make it easier to divide lamination stacks, wherein the dividing element has a flat support with an adhesive coating consisting of a UV-cross-linked acrylic-based hot-melt pressure-sensitive adhesive on a first flat side of the flat support, the method comprising stacking the dividing element together with a plurality of sheet metal parts and connecting the plurality of sheet metal parts to one another through integral joining to form the lamination stacks.

9. The method according to claim 8, wherein the adhesive coating on the flat support has a weight per unit area in the a range from 9 to 13 g/m² and/or a layer thickness in a range from 10 to 17 μm.

10. The method according to claim 8, wherein the flat support is composed of a material selected from the group consisting of a woven, a nonwoven, a film, and a polyester film.

11. The method according to claim 8, wherein the flat support has a support thickness in a range from 40 to 60 μm.

12. The method according to claim 8, wherein the dividing element has a nonstick coating on the a second flat side of the support opposite from the first flat side of the support with the adhesive coating.

13. The method according to claim 12, wherein the nonstick coating is a cross-linked, silicone coating and/or has a layer thickness in a range from 1.0 to 3.5 μm.

14. A lamination stack produced by the method according to claim 1, with the at least one dividing element at one end of the plurality of lamination stacks.

15. The lamination stack according to claim 14, the at least one dividing element forms an electrical insulation layer.

16. The method according to claim 5, wherein the nonstick coating is a silicone-based nonstick coating.

17. The method according to claim 6, wherein the cross-linked, silicone coating is solvent-free.

18. The method according to claim 12, wherein the nonstick coating is a silicone-based nonstick coating.

19. The method according to claim 13, wherein the cross-linked, silicone coating is solvent-free.
